(19) United States
(12) Patent Application Publication
(10) Pub. No.: US 2019/0360552 A1
(43) Pub. Date: Nov. 28, 2019

(54) SYSTEM FOR REDUCING VIBRATIONS TRANSMITTED TO SENSORS MOUNTED ON A TILLAGE IMPLEMENT

(71) Applicants: CNH Industrial Canada, Ltd., Mendon, UT (US); Autonomous Solutions, Inc., Mendon, UT (US)

(72) Inventors: James W. Henry, Saskatoon (CA); Luca Ferrari, Formigine (IT); Taylor C. Bybee, Logan, UT (US)

(73) Assignees: CNH Industrial Canada, Ltd.; Autonomous Solutions, Inc.

(21) Appl. No.: 15/988,648

(22) Filed: May 24, 2018

(51) Int. Cl. F16F 15/023; A01B 49/02; A01B 76/00; B60R 11/04; H04N 5/232; H04N 5/225; G01S 7/481; G01S 13/88; G01S 17/88

(52) U.S. Cl. CPC F16F 15/023; A01B 49/027; A01B 76/00; B60R 11/04; A01B 31/00; H04N 5/2253; G01S 7/4813; G01S 13/88; G01S 17/88; H04N 5/2328

(57) ABSTRACT

In one aspect, a system for reducing the vibrations transmitted to sensors mounted on a tillage implement may include an implement frame and a vision-based sensor coupled to the implement frame. The vision-based sensor may be oriented relative to the implement frame such that a portion of the ground is positioned within a field of view of the vision-based sensor. As such, the vision-based sensor may be configured to capture image data of the soil positioned within the field of view. The system may also include a damper coupled between the vision-based sensor and the implement frame. The damper may be configured to allow relative movement between the vision-based sensor and the frame to reduce a magnitude of the vibrations transferred from the implement frame to the vision-based sensor.

### FIELD

The present disclosure generally relates to tillage implements and, more particularly, to systems for reducing the vibrations transmitted to sensors, such as vision-based sensors, mounted on a frame of a tillage implement.

### BACKGROUND

Tillage implements, such as cultivators, disc harrows, and/or the like, perform one or more tillage operations while being towed across a field by a suitable work vehicle, such as in agricultural tractor. In this regard, tillage implements often include one or more sensors mounted thereon to monitor various parameters associated with the performance of such tillage operations. For example, some tillage implements include one or more vision-based sensors (e.g., cameras) that capture images of the soil within the field. Thereafter, such image data may be processed or analyzed to determine one or more parameters associated with the condition of soil, such as parameters related to soil roughness, residue coverage, and/or the like.

During the performance of agricultural operations, the implement may encounter topographical irregularities (e.g., ridges, bumps, holes, and/or depressions) and impediments (e.g., rocks) within the field. The topographical irregularities and impediments may jar the implement, thereby causing one or more components of the implement (e.g., the implement frame) to vibrate. Such vibrations are, in turn, transmitted from the implement frame to the vision-based sensors, which may result in the image data being captured by the vision-based sensors having poor quality.

Accordingly, an improved system for reducing vibrations transmitted to sensors mounted on a tillage implement would be welcomed in the technology.

### BRIEF DESCRIPTION

Aspects and advantages of the technology will be set forth in part in the following description, or may be obvious from the description, or may be learned through practice of the technology.

In one aspect, the present subject matter is directed to a system for reducing the vibrations transmitted to sensors mounted on a tillage implement. The system may include an implement frame and a vision-based sensor coupled to the implement frame. The vision-based sensor may be oriented relative to the implement frame such that a portion of the ground is positioned within a field of view of the vision-based sensor. As such, the vision-based sensor may be configured to capture image data of the soil positioned within the field of view. The system may also include a damper coupled between the vision-based sensor and the implement frame. The damper may be configured to allow relative movement between the vision-based sensor and the frame to reduce a magnitude of the vibrations transferred from the implement frame to the vision-based sensor.

In another aspect, the present subject matter is directed to a tillage implement. The tillage implement may include a frame having a forward end and an aft end and a plurality of ground engaging tools coupled to the frame. The tillage implement may also include a vision-based sensor configured to capture image data associated with a field of view of the vision-based sensor. Furthermore, the tillage implement may include a support arm configured to support the vision-based sensor at or adjacent to one of the forward end or the aft end of the frame such that a portion of the ground is positioned within the field of view of the vision-based sensor. Additionally, the tillage implement may include a mounting device coupled between the frame and the support arm, with the mounting device being configured to permit relative movement between the vision-based sensor and the frame.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a tillage implement in accordance with aspects of the present subject matter;

FIG. 2 illustrates a side view of one embodiment of a system for reducing vibrations transmitted to sensors mounted on a tillage implement in accordance with aspects of the present subject matter;

FIG. 3 illustrates a cross-sectional view of one embodiment of a dashpot for use in the system shown in FIG. 2 in accordance with aspects of the present subject matter, particularly illustrating various features thereof; and

FIG. 4 illustrates a side view of another embodiment of a system for reducing vibrations transmitted to sensors mounted on a tillage implement in accordance with aspects of the present subject matter, particularly illustrating a damper directly coupling one of the sensors to an implement frame.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system for reducing the vibrations transmitted to sensors mounted on a tillage implement. Specifically, the disclosed system may include one or more components that reduce the vibrations transmitted from various portions of the implement (e.g., an implement frame) to one or more vision-based sensors mounted on the implement, thereby improving the quality of image data captured by such sensor(s). For example, in several embodiments, the system may include a damper, such as a dashpot, coupled between the implement frame and the vision-based sensor(s). In one embodiment, the damper may be coupled between the implement frame and an arm to which the vision-based sensor(s) is mounted. As such, the damper may be configured to allow relative movement between the vision-based sensor(s) and the implement frame to reduce a magnitude of the vibrations transferred from the implement frame to the vision-based sensor(s).

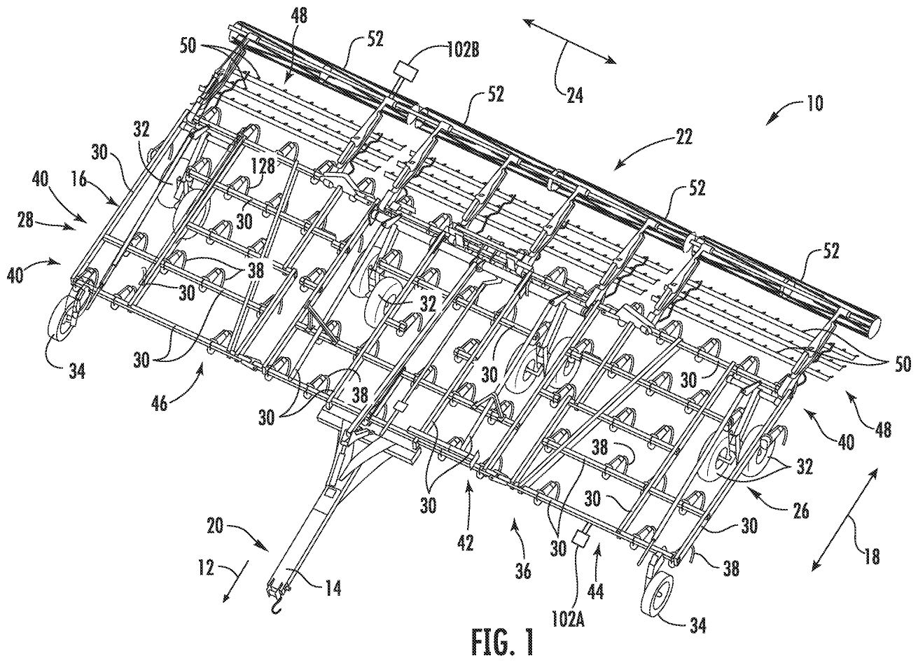

Referring now to the drawings, FIG. 1 illustrates a perspective view of one embodiment of a tillage implement 10 in accordance with aspects of the present subject matter. As shown in the illustrated embodiment, the implement 10 may be configured to be towed across a field in a direction of travel (e.g., as indicated by arrow 12) by a work vehicle (not shown), such as a tractor or other agricultural work vehicle. The implement 10 may be coupled to the work vehicle via a hitch assembly 14 or using any other suitable attachment means.

The implement 10 may include the implement frame 16. As shown, the frame 16 may extend along a longitudinal direction 18 between a forward end 20 and an aft end 22. The frame 16 may also extend along a lateral direction 24 between a first side 26 and a second side 28. In this respect, the frame 16 generally includes a plurality of structural frame members 30, such as beams, bars, and/or the like, configured to support or couple to a plurality of components. Additionally, a plurality of wheels may be coupled to the frame 16, such as a set of centrally located wheels 32 and a set of front pivoting wheels 34, to facilitate towing the implement 10 in the direction of travel 12.

In one embodiment, the frame 16 may be configured to support a cultivator 36, which may be configured to till or otherwise break the soil over which the implement 10 travels to create a seedbed. In this respect, the cultivator 36 may include a plurality of shanks 38, which are pulled through the soil as the implement 10 moves across the field in the direction of travel 12. The shanks 38 may be configured to be pivotally mounted to the frame 16 to allow the shanks 38 pivot out of the way of rocks or other impediments in the soil. As shown, the shanks 38 may be arranged into a plurality of ranks 40, which are spaced apart from one another along the longitudinal direction 18 between the forward end 20 and the aft end 22 of the frame 16.

In several embodiments, the frame 16 may include one or more sections. As illustrated in FIG. 1, for example, the frame 16 may include a main section 42 positioned centrally between the first and second sides 26, 28 of the frame 16. The frame 16 may also include a first wing section 44 positioned proximate to the first side 26 of the frame 16. Similarly, the frame 16 may also include a second wing section 46 positioned proximate to the second side 28 of the frame 16. The first and second wing sections 44, 46 may be pivotally coupled to the main section 42 of the frame 16. In this respect, the first and second wing sections 44, 46 may be configured to fold up relative to the main section 42 to reduce the lateral width of the implement 10 to permit, for example, storage or transportation of the implement on a road. In should be appreciated that the frame 16 may include any suitable number of wing sections.

Moreover, the implement 10 may also include one or more harrows 48. As is generally understood, the harrows 48 may be configured to be pivotally coupled to the frame 16. The harrows 48 may include a plurality of ground engaging elements 50, such as tines or spikes, which are configured to level or otherwise flatten any windrows or ridges in the soil created by the cultivator 36. Specifically, the ground engaging elements 50 may be configured to be pulled through the soil as the implement 10 moves across the field in the direction of travel 12. It should be appreciated that the implement 10 may include any suitable number of harrows 48. In fact, some embodiments of the implement 10 may not include any harrows 48.

Furthermore, in one embodiment, the implement 10 may optionally include one or more baskets or rotary firming wheels 52. As is generally understood, the baskets 52 may be configured to reduce the number of clods in the soil and/or firm the soil over which the implement 10 travels. As shown, each basket 52 may be configured to be pivotally coupled to one of the harrows 48. Alternately, the baskets 52 may be configured to be pivotally coupled to the frame 16 or any other suitable location of the implement 10. It should be appreciated that the implement 10 may include any suitable number of baskets 52. In fact, some embodiments of the implement 10 may not include any baskets 52.

Additionally, the tillage implement 10 may include one or more vision-based sensors 102 coupled thereto and/or supported thereon. As will be described below, each vision-based sensor 102 may be configured to capture image data and and/or other vision-based data from the field (e.g., of the soil present within the field) across which the implement 10 is moved. Specifically, in several embodiments, the vision-based sensor(s) 102 may be provided in operative association with the implement 10 such that the vision-based sensor(s) 102 has a field of view or sensor detection range directed towards a portion(s) of the field adjacent to the implement 10. For example, as shown in FIG. 1, in one embodiment, one vision-based sensor 102A may be provided at the forward end 20 of the first wing section 44 of the implement 10 to allow the vision-based sensor 102A to capture image data of a section of the field disposed in front of the first wing section 44. Conversely, as shown in FIG. 1, a second vision-based sensor 102B may be provided at or adjacent to the aft end 22 of the second wing section 46 of the implement 10 to allow the vision-based sensor 102B to capture image data of a section of the field disposed behind the second wing section 46. It should be appreciated that, in alternative embodiments, the vision-based sensors 102A, 102B may be installed at any other suitable location(s) on the implement 10. For example, the sensors 102A, 102B may be coupled to the aft end 22 of the first wing section 44, the forward or aft ends 20, 22 of the main section 42 of the implement 10, and/or the forward end 20 of the second wing section 46. Additionally, it should be appreciated that the implement 10 may include only one vision-based sensor 102 mounted on either the front or aft ends 20, 22 of the implement 10 or more than two vision-based sensors 102 mounted at various locations on the implement 10.

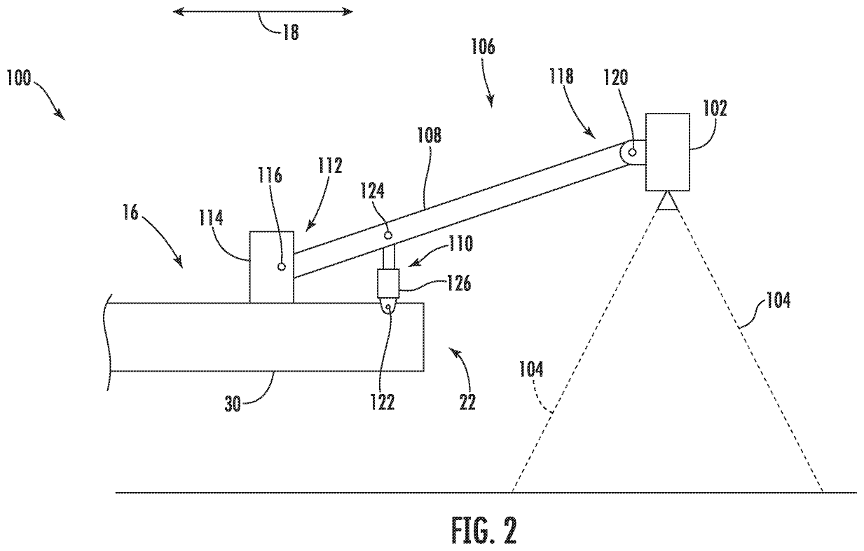

Moreover, it should be appreciated that the vision-based sensor(s) 102 may correspond to any suitable sensing device(s) configured to detect or capture image data or other vision-based data (e.g., point cloud data) associated with the soil present within an associated field of view (FIG. 2). For example, in several embodiments, the vision-based sensor(s) 102 may correspond to a suitable camera(s) configured to capture three-dimensional images of the soil surface or the plants present with in the associated field of view. For instance, in a particular embodiment, the vision-based sensor(s) 102 may correspond to a stereographic camera(s) having two or more lenses with a separate image sensor for each lens to allow the camera(s) to capture stereographic or three-dimensional images. However, in alternative embodiments, the vision-based sensor(s) 102 may correspond to Light Detection and Ranging (LIDAR) sensor(s), Radio Detection and Ranging (RADAR) sensor(s) (e.g., imaging RADAR), or any other suitable vision-based sensing device(s).

It should further be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

Referring now to FIG. 2, a side view of one embodiment of a system 100 for reducing vibrations transmitted to sensors mounted on a tillage implement is illustrated in accordance with aspects of the present subject matter. In general, the system 100 will be described herein with reference to the implement 10 described above with reference to FIG. 1. However, it should be appreciated by those of ordinary skill in the art that the disclosed system 100 may generally be utilized with implements having any other suitable implement configuration.

As shown in FIG. 2, the system 100 may include one or more components of the tillage implement 10 described above with reference to FIG. 1. For example, in several embodiments, the system 100 may include the vision-based sensor(s) 102. However, it should be appreciated that the system 100 may include any other suitable components of the tillage implement 10, such as the implement frame 16.

As indicated above, each vision-based sensor 102 may be configured to capture image data or other vision-based data within its associated field of view (e.g., as indicated by dashed lines 104 in FIG. 2). In several embodiments, the system 100 may include a mounting device 106 configured to mount or otherwise couple an associated vision-based sensor 102 to the implement frame 16 in any suitable manner that permits the vision-based sensor 102 to capture image data of the desired section(s) of the field across which the implement 10 is moved. For example, as shown, in one embodiment, the vision-based sensor 102 may be coupled at or adjacent to the aft end 22 of the implement frame 16 by the mounting device 106 in a manner that permits the vision-based sensor 102 to capture image data of a portion of the field located aft of the implement 10. In an alternative embodiment, the vision-based sensor 102 may be coupled at or adjacent to the forward end 20 of the implement frame 16 by the mounting device 106 in a manner that permits the vision-based sensor 102 to capture image data of a portion of the field located forward of the implement 10. In a further embodiment, the vision-based sensor 102 may be coupled at or adjacent to the first side 26 or the second side 28 of the implement frame 16 by the mounting device 106 in a manner that permits the vision-based sensor 102 to capture image data of a portion of the field located adjacent to the corresponding first side 26 or the second side 28 of the implement 10. However, it should be appreciated that, in alternative embodiments, the mounting device 106 may be coupled to any other suitable portion of the implement frame 16.

In several embodiments, the mounting device 106 may include a support arm 108 and a damper 110 configured to support the vision-based sensor 102 relative to the implement frame 16. For example, as shown in FIG. 2, in one embodiment, the support arm 108 may be configured to support the vision-based sensor 102 at a location aft of the aft end 22 of the implement 10. In this regard, a forward end 112 of the support arm 108 may be pivotably coupled to a post 114 at a pivot joint 116, with the post 114, in turn, being coupled to one of the frame members 30 of the implement frame 16. Similarly, an aft end 118 of the support arm 106 may be pivotably coupled to the vision-based sensor 102 at a pivot joint 120. Furthermore, one end of the damper 110 may be pivotably coupled to the frame member 30 at a pivot joint 122. Similarly, an opposed end of the damper 110 may be pivotably coupled to the support arm 108 at a pivot joint 124 positioned along the length of the support arm 108 at a location between the pivot joints 116, 120. As such, the pivot joints 116, 120, 122, 124 may allow relative pivotable movement between the implement frame 16, the support arm 108, the damper 110, and the vision-based sensor 102.

In accordance with aspects of the present subject matter, the damper 110 may be configured to reduce the magnitude of the vibrations transferred from the implement frame 16 to the vision-based sensor 102. In general, when the implement 10 is jarred (e.g., by hitting a rock or bump in the field), such shock impulses caused by such jarring may incite or otherwise create vibrations within one or more components of the implement 10, such as the implement frame 16. In this regard, the damper 110 may be configured to dissipate or otherwise absorb the vibrations of the implement frame 16 being transferred to the vision-based sensor 102. Specifically, when vibrations are incited within the implement frame 16, the damper 110 may be configured to allow pivotable movement between the implement frame 16, the support arm 108, the damper 110, and the vision-based sensor 102 such that the magnitude of the vibrations transferred to the vision-based sensor 102 are reduced. That is, the relative movement between the vision-based sensor 102 and the implement frame 16 may prevent the full magnitude of the vibrations within the implement frame 16 from being transferred to the vision-based sensor 102. The damper 110 may further be configured to dissipate the relative movement between the vision-based sensor 102 and the implement frame 16 over a period of time (e.g., about two to five seconds in certain instances), thereby further reducing the magnitude of the vibrations transferred to the vision-based sensor 102.

It should be appreciated that the damper 110 may correspond to any suitable device configured to operate as described above. Thus, in several embodiments, the damper 110 may correspond to any suitable fluid-filled damper, such as a dashpot. However, in other embodiments, the damper 110 may correspond to any other type of damper, such as a rubber or elastomeric-based damper configured to be coupled between the implement frame 16 and the support arm 108.

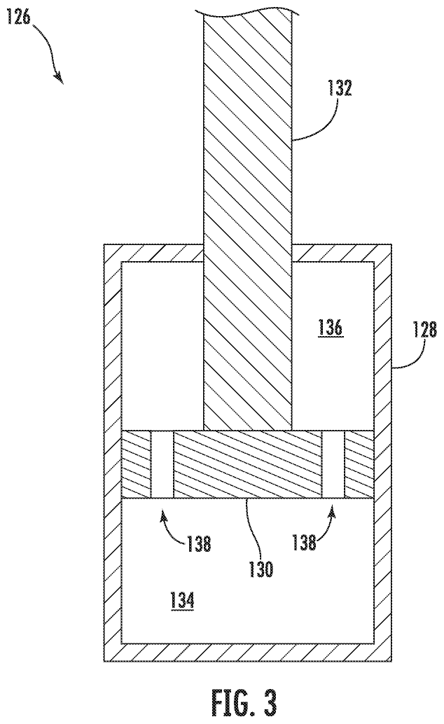

Referring now to FIG. 3, a cross-sectional view of one embodiment of a suitable dashpot 126 configured for use within the disclosed system 100 is illustrated in accordance with aspects of the present subject matter. In general, the dashpot 126 may reduce the magnitude of the vibrations transferred from the implement frame 16 to the vision-based sensor 102 by permitting relative movement therebetween and dissipating such relative movement by converting it to heat. For example, the dashpot 126 may include a cylinder 128 configured to house a piston 130 and a rod 132 coupled to the piston 130 that extends outwardly from the cylinder 128. Additionally, the dashpot 126 may include a cap-side chamber 134 and a rod-side chamber 136 defined within the cylinder 128. As shown, the piston 132 may define a plurality of fluid passages 138 that fluidly couple the cap-side and rod-side chambers 134, 136. In this regard, when relative movement occurs between the implement frame 16 and the vision-based sensor 102, the piston 130 is moved relative to the cylinder 128. Such movement causes fluid present within one of the cap-side or rod-side chambers 134, 136 to be forced through the fluid passages 108 defined by the piston 130 into the other of the cap-side or rod-side chambers 134, 136. As the fluid is forced between the cap-side and rod-side chambers 134, 136, the relative movement between the piston 130 and the cylinder 128 and, in turn, the relative movement between the implement frame 16 and the vision-based sensor 102 is dissipated as heat, which is transferred to the fluid. However, it should be appreciated that, in alternative embodiments, the dashpot 126 may have any other suitable configuration.

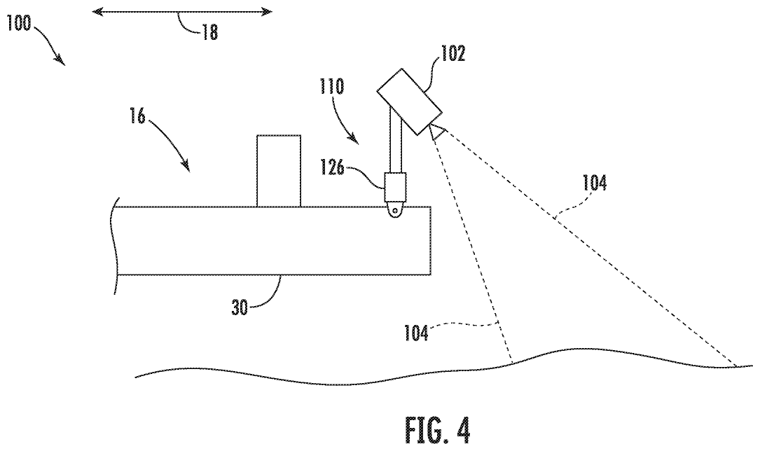

Referring now to FIG. 4, a side view of another embodiment of the system 100 described above with reference to FIG. 2 is illustrated in accordance with aspects of the present subject matter. As shown, the system 100 may generally be configured the same as or similar to that described above with reference to FIG. 2. For instance, the system 100 may include a damper 110, such as a dashpot 126, configured to allow relative movement between the implement frame 16 and the vision-based sensor 102 to reduce the magnitude of the vibrations transferred from the implement frame 16 to the vision-based sensor 102. However, as shown in FIG. 4, unlike the above-described embodiment, the damper 110 may be directly coupled between the implement frame 16 and the vision-based sensor 102. Specifically, in one embodiment, one end of the damper 110 may be directly coupled to one of the frame members 30 of the implement frame 16. Similarly, an opposed end of the damper 110 may be directly coupled to the vision-based sensor 102. It should be appreciated that, in alternative embodiments, the damper 110 may be configured to coupled between the implement frame 16 and the vision-based sensor 102 in any other suitable manner that permits relative movement between the implement frame 16 and the vision-based sensor 102.

In the embodiments of the system 100 described above with reference to FIGS. 2 through 4, the damper 110 is configured to passively reduce the magnitude of the vibrations transferred from the implement frame 16 to the vision-based sensor 102. That is, the damper 110 relies on the inherent damping properties of the materials from which it is constructed (e.g., the fluid present within the cap-side and rod-side chambers 134, 136 of the dashpot 126) to dissipate the energy of the vibrations. As such, in several embodiments, the system 100 may not require a controller or sensors to operate. However, it should be appreciated that, in alternative embodiments, the damper 110 may be dynamically controlled, such as by a suitable controller based on feedback received from one or more sensors, to reduce the magnitude of the vibrations transferred from the implement frame 16 to the vision-based sensor 102.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for reducing the vibrations transmitted to sensors mounted on a tillage implement, the system comprising:
an implement frame;
a vision-based sensor coupled to the implement frame, the vision-based sensor being oriented relative to the implement frame such that a portion of the ground is positioned within a field of view of the vision-based sensor, the vision-based sensor being configured to capture image data of the soil positioned within the field of view; and
a damper coupled between the vision-based sensor and the implement frame, the damper being configured to allow relative movement between the vision-based sensor and the frame to reduce a magnitude of the vibrations transferred from the implement frame to the vision-based sensor.

2. The system of claim 1, wherein the damper comprises a fluid-filled damper.

3. The system of claim 2, wherein the fluid-filled damper comprises a dashpot.

4. The system of claim 1, wherein the damper is configured to passively reduce the magnitude of the vibrations transferred from the implement frame to the vision-based sensor.

5. The system of claim 1, further comprising:
a support arm configured to support the vision-based sensor relative to the implement frame.

6. The system of claim 5, wherein the damper is coupled between the support arm and the implement frame.

7. The system of claim 1, wherein the vision-based sensor is coupled to an aft end of the implement frame.

8. The system of claim 1, wherein the vision-based sensor comprises a camera.

9. The system of claim 1, wherein the vision-based sensor comprises at least one of a light detection and ranging (LIDAR) sensor or a radio detection and ranging (RADAR) sensor.

10. A tillage implement, comprising:
a frame including a forward end and an aft end;
a plurality of ground engaging tools coupled to the frame;
a vision-based sensor configured to capture image data associated with a field of view of the vision-based sensor;
a support arm configured to support the vision-based sensor at or adjacent to one of the forward end or the aft end of the frame such that a portion of the ground is positioned within the field of view of the vision-based sensor; and
a mounting device coupled between the frame and the support arm, the mounting device being configured to permit relative movement between the vision-based sensor and the frame.

11. The tillage implement of claim 10, wherein the mounting device comprises a damper configured to reduce a magnitude of the vibrations transferred from the frame to the vision-based sensor.

12. The tillage implement of claim 11, wherein the damper comprises a fluid-filled damper.

13. The tillage implement of claim 12, wherein the damper comprises a dashpot.

14. The tillage implement of claim 10, wherein the damper is configured to passively reduce the magnitude of the vibrations transferred from the frame to the vision-based sensor.

15. The tillage implement of claim 10, wherein the support arm is configured to support the vision-based sensor at or adjacent to the aft end of the frame.

16. The tillage implement of claim 10, wherein the vision-based sensor comprises a camera.

17. The tillage implement of claim 10, wherein the vision-based sensor comprises at least one of a light detection and ranging sensor (LIDAR) sensor or a radio detection and ranging (RADAR) sensor.
